(19) United States
(12) Patent Application Publication
(10) Pub. No.: US 2008/0201369 A1
(43) Pub. Date: Aug. 21, 2008

(54) System and method of modifying media content

(75) Inventor: Juan Cordoba, Austin, TX (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/707,753

(22) Filed: Feb. 16, 2007

(51) Int. Cl. G06F 7/00

(52) U.S. Cl. 707/104.1; 707/E17.009

(57) ABSTRACT

A method of modifying media content is disclosed that includes receiving data from a destination device identifying a media content selection and an attribute preference. The method further includes identifying an attribute associated with media content related to the media content selection. The method further includes modifying the attribute based on the attribute preference to produce modified media content and providing the modified media content to the destination device.

### FIELD OF THE DISCLOSURE

The present disclosure relates to systems and methods of modifying media content.

### BACKGROUND

In general, media content may be downloaded to a subscriber device, such as a set-top box device. The downloaded media content may include media content such as video content, audio content, or a combination thereof. Typically, such media content is presented to a display device without modification. However, a viewer may wish to modify aspects of the media content. Hence, there is a need for a system and method of modifying media content.

### BRIEF DESCRIPTION OF THE DRAWINGS

FIG. 1 is a block diagram of a particular illustrative embodiment of a system to modify media content;

FIG. 2 is a block diagram of a second particular illustrative embodiment of a system to modify media content;

FIG. 3 is a flow diagram of a particular illustrative embodiment of a method of modifying media content;

FIG. 4 is a flow diagram of a second particular illustrative embodiment of a method of modifying media content;

FIG. 5 is a diagram of a particular illustrative embodiment of a user interface including a selectable indicator to access an attribute menu associated with particular media content;

FIG. 6 is a block diagram of a second particular illustrative embodiment of a user interface to configure visual attributes associated with particular media content;

FIG. 7 is a block diagram of a third particular illustrative embodiment of a user interface to configure audio attributes associated with particular media content; and

FIG. 8 is a block diagram of an embodiment of a general computer system.

### DETAILED DESCRIPTION OF THE DRAWINGS

In a particular embodiment, a method of modifying media content is provided that includes receiving data from a destination device indicating a media content selection and an attribute preference. The method further includes identifying an attribute associated with media content related to the media content selection, modifying the attribute based on the attribute preference to produce modified media content, and providing the modified media content to the destination device.

In another particular embodiment, a method of modifying media content is disclosed that includes sending an attribute interface to a display device, the attribute interface including a plurality of selectable options related to modifiable attributes of media content. The method further includes receiving a selection of one of the plurality of selectable options via the attribute interface, modifying the media content based on the selection to produce modified media content, and providing the modified media content to the display device.

In another particular embodiment, a system to modify media content is disclosed. The system includes a memory to store media content including audio data and video data, and to store user attribute preferences related to the media content. The system further includes a visual attribute detection module to determine a set of visual attributes related to the media content. The system also includes an audio attribute detection module to determine a set of audio attributes related to the media content. The system further includes a content modification module to modify at least one attribute of the set of visual attributes, of the set of audio attributes, or any combination thereof to produce modified media content.

In another particular embodiment, a processor readable medium is disclosed that embodies processor readable instructions that are executable by a processor to receive an input selection including a media content selection and an attribute preference. The processor readable medium also includes instructions to determine one or more attributes associated with media content related to the media content selection. The media content includes video data, audio data, or any combination thereof. The processor readable medium further includes instructions to modify at least one of the one or more attributes based on the attribute preference to produce modified media content.

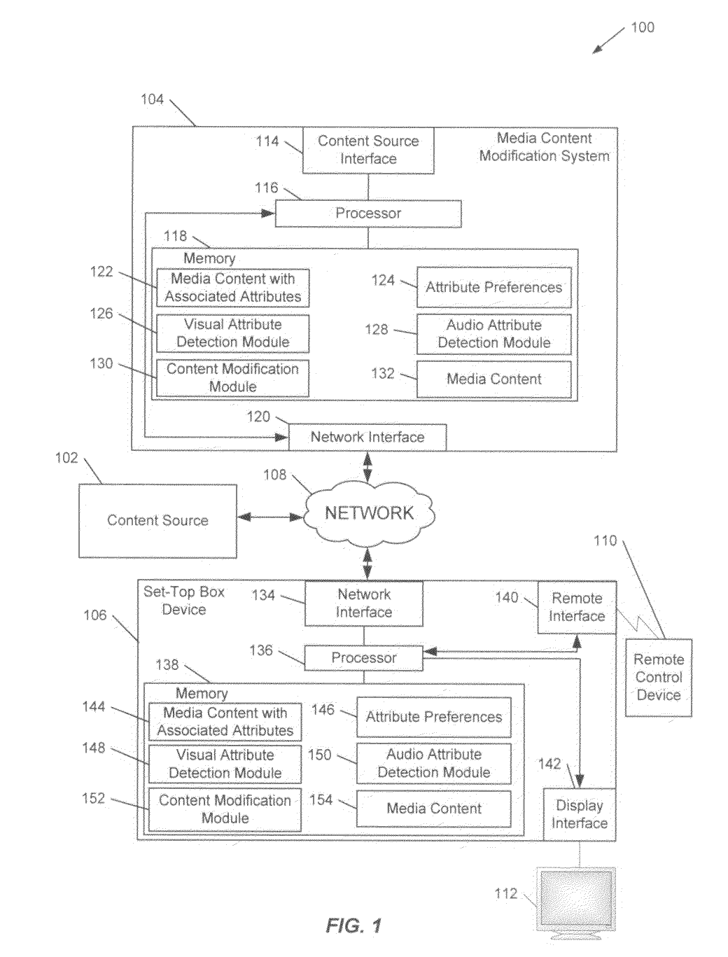

FIG. 1 is a block diagram of a particular illustrative embodiment of a system 100 to modify media content. The system 100 includes a content source 102 that may communicate with a media content modification system 104 via a network 108. The system 100 also includes a set-top box device 106 communicating with the media content modification system via the network 108. In an illustrative embodiment, the network 108 can be an access network of an Internet Protocol Television (IPTV) system. The system 100 can also include a remote control device 110 that communicates with the set-top box device 106. Further, the system 100 can also include a display device 112 communicatively coupled to the set-top box device 106.

In a particular embodiment, the media content modification system 104 may include a content source interface 114, a processor 116, a memory 118 accessible to the processor 116, and a network interface 120. The memory 118 may store media content with associated attributes 122, attribute preferences 124, a visual attribute detection module 126, an audio attribute detection module 128, a content modification module 130, and other media content storage 132. In general, the visual attribution detection module 126, the audio attribute detection module 128, and the content modification module 130 may include processor readable instructions that may be executed by the processor 116. In another embodiment, the modules 126-130 can include hardware logic, instructions, or any combination thereof.

In a particular embodiment, the set-top box device 106 may include a network interface 134, a processor 136, memory 138 accessible to the processor 136, a remote interface 140, and a display interface 142. The memory 138 may include media content with associated attributes storage 144, attribute preferences storage 146, a visual attribute detection module 148, an audio attribute detection module 150, a content modification module 152, and other media content 154. The visual attribute detection module 148, the audio attribute detection module 150, and the content modification module 152 may include processor readable instructions that may be executed by the processor 136. In another embodiment, the modules 148-152 may include hardware logic, instructions, or any combination thereof.

In an illustrative embodiment, a user may access a menu or other interface at the set-top box device 106 to view attributes related to particular media content at the display device 112. For example, a user may access an attribute menu related to a television program, such as “Sex in the City.” The attribute menu may include configurable attributes that the user may change, causing the television program to be displayed or related audio to be reproduced in a modified form at the display device 112. For example, the attribute menu may allow a user to change the hair color and the eye color of a particular character within the television program. Additionally, the attribute menu may allow a user to change an audio characteristic associated with one or more of the characters to alter the audio output of the character's spoken lines to include a selected accent, language, or other audio characteristic. In general, the number of attributes that may be accessed and changed by a user may vary, depending on the particular media content. For example, a first television program may allow a user to alter only an audio attribute, while a second television program may allow a user to change a variety of audio attributes, video attributes, or any combination thereof.

In a particular embodiment, the media content modification system 104 may receive data indicating an input selection from the set-top box device 106 via the network 108. The input selection may include a media content selection and may also include an attribute preference related to the selected media content. The media content modification system 104 may identify an attribute associated with the media content and modify the media content based on the attribute preference. The media content modification system 104 may send the modified media content to the set-top box device 106.

In a particular illustrative embodiment, the content source 102 may provide content to the media content modification system 104 based on a request received from the set-top box device 106 at the media content modification system 104. The request may include a media content selection. The media content received from the content source 102 may be stored at the media content storage 132. The processor 116 may execute instructions associated with the visual attribute detection module 126 and/or the audio attribute detection module 128 to identify configurable attributes associated with the media content. In a particular embodiment, the media content modification system 104 may associate attributes with particular aspects of the media content. In another particular embodiment, the content source 102 may associate attributes with particular aspects of the media content. The processor 116 may store the media content and the associated attributes in the media content with associated attributes storage 122.

In a particular illustrative embodiment, the processor 116 may modify one or more of the attributes according to one or more attribute preferences 124 associated with the set-top box device 106 and stored at the attribute preferences module 124. The processor 116 may transmit the modified media content to the set-top box device 106 via the network interface 120 and the network 108. The set-top box device 106 may receive the modified media content and may provide the modified content to the display device 112 via the display interface 142.

In another particular illustrative embodiment, the media content modification system 104 may transmit the media content with associated attributes to the set-top box device 106. The set-top box device 106 may store the media content with associated attributes at the media content with associated attributes storage 144. The processor 136 may selectively change one or more of the associated attributes to produce modified media content, which may be provided to the display device 112 via the display interface 142.

In a particular embodiment, attributes associated with the media content may include visual attributes, such as hair color, eye color, skin color, backgrounds, and other visual attributes. Additionally, the attributes may include one or more audio attributes, such as an accent attribute, a language attribute, a dialect attribute, a musical accompaniment, a dialogue enhancement, a bass enhancement; or any combination thereof.

In an illustrative embodiment, the media content modification system 104 may operate as a network digital video recorder, storing the modified content in the memory 118 and providing the modified content to a destination device, such as the set-top box device 106, at a later time. In another example, the set-top box device 106 may store the modified content in the memory 138 and may provide the modified content to the display device 112 at a later time.

In another particular embodiment, the set-top box device 106 may transmit a request for video content to the media content modification system 104 via the network 108. The media content modification system 104 may retrieve the requested media content from the content source 102 and send the requested media content to the set-top box device 106 via the network 108. The set-top box device 106 may store the media content at the media content module 154, or the set-top box device 106 may process the media content as it is received. The set-top box device 106 may receive attribute preferences from a user via the remote control device 110 via the remote interface 140 and may store the attribute preferences at the attribute preferences storage 146. The processor 136 may execute instructions associated with the visual attribute detection module 148, the audio attribute detection module 150, or any combination thereof to search for and identify attributes associated with the media content. The processor 136 may store the media content with associated attributes at the media content with associated attributes storage 144. The processor 136 may modify an attribute associated with the media content according to an attribute preferences stored in the attribute preferences storage 146 to produce modified media content. The set-top box device 106 may send the modified media content to the display device 112 via the display interface 142. In a particular illustrative embodiment, the set-top box device 106 may store the modified media content in the memory 138 for delivery to the display device 112 at a later time.

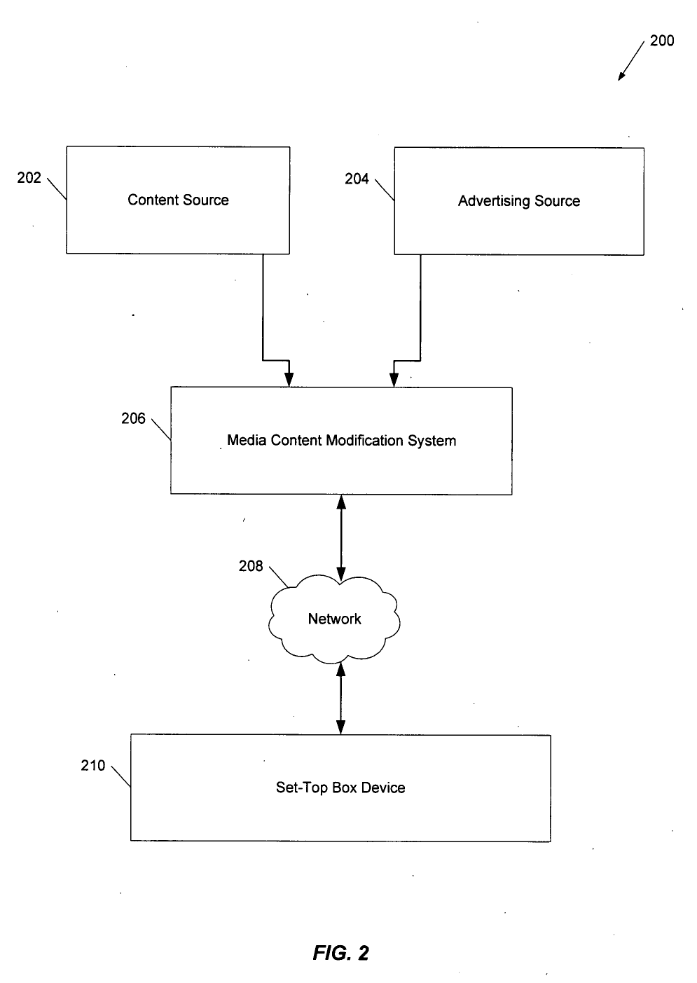

FIG. 2 is block diagram of a second particular illustrative embodiment of a system 200 to modify media content. The system 200 includes a content source 202 and an advertising source 204 communicating with a media content modification system 206. The content source 202, the advertising source 204, and the media content modification system 206 may communicate via a network (not shown). The system 200 can also include a set-top box device 210 that may communicate with the media content modification system 206 via a network 208.

In a particular illustrative embodiment, the content source 202 may provide media content, such as a television program, to the media content modification system 206. The media content may include product placements. For example, a particular television program may include a local or regional product as a prop. The content source 202 may assign a product attribute to the prop, such that various products can be inserted into the television content. In general, attributes may be associated with media content by the content source 202, by the advertising source 204, by the media content modification system 206, or by the set-top box device 210. The system 200 allows the prop to be changed by modifying the corresponding product attribute. Thus, product placements can be changed, e.g., based on regions. For instance, one brand of soda may appear in the television program in the Northeast, while another brand of soda may appear in the television program in the Southwest broadcast region. In an alternative embodiment, the product shown within a particular television program may vary based on the subscriber's home address, buying preferences, user profile, demographic profile, or any combination thereof.

In another particular illustrative embodiment, the advertising source 204 may provide advertising content including one or more advertisement attributes. The advertising source 204 may also provide one more replacement rules associated with the advertisement attribute. The replacement rules may be used to alter the look of a particular product within a particular region, such as the appearance of a soda can in Mexico, as opposed to the United States. The advertising source 204 may assign provide the advertisement, associated attributes, and replacement rules to the media content modification system 206. The media content modification system 206 may modify the appearance of a product associated with an advertising attribute, based on the replacement rule(s). The modified advertisement may be transmitted to the set-top box device 210 via the network 208. In an illustrative example, the advertising source 204 may provide a replacement rule to modify a visual representation of a product name, for instance, replacing Coca Cola® with Coke®.

In another illustrative embodiment, the content source 202 may provide one or more replacement rules to the content modification system 206. The content modification system 206 may apply the received replacement rules to the media content received from the content source 202 and transmit the modified media content to the set-top box device 210 via the network 208. In a particular illustrative embodiment, a content provider associated with the content source 202 may sell advertising and product placement opportunities to advertising companies. Based on agreements between the content provider and such companies, a user at the content may configure the content source 202 to provide one or more replacement rules based on such agreements

In yet another particular illustrative embodiment, the set-top box device 210 may supply one or more replacement rules and apply the replacement rules to received media content to produce modified media content. In exchange for applying the replacement rules to the received media content to produce the modified media content, the advertising source 204 may provide compensation to the content provider associated with the set-top box device 210.

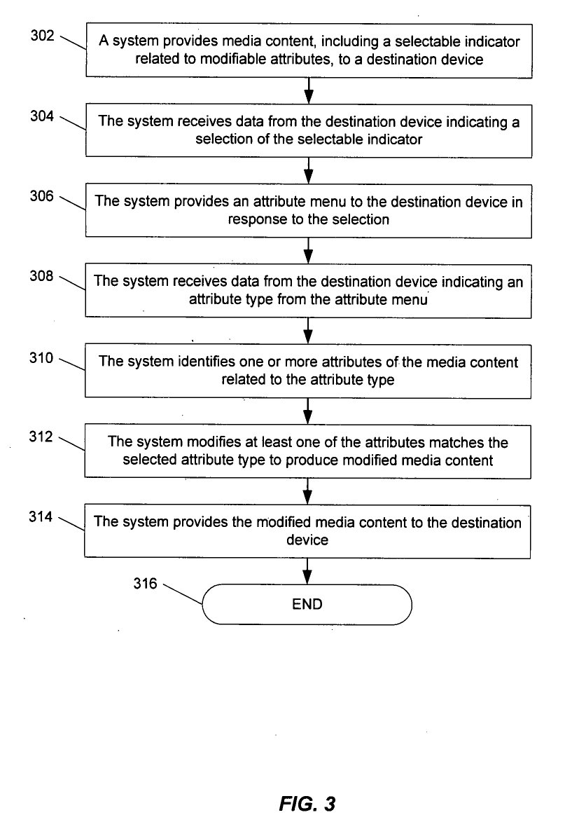

FIG. 3 is a flow diagram of a particular embodiment of a method of modifying media content. At block 302, a system provides media content, including a selectable indicator related to modifiable attributes, to a destination device. Moving to block 304, the system receives data from the destination device indicating a selection of the selectable indicator. Advancing to block 306, the system provides an attribute menu to the destination device in response to the selection. Proceeding to block 308, the system receives data from the destination device indicating an attribute type from the attribute menu. Continuing to block 310, the system identifies one or more attributes of the media content related to the attribute type. Moving to block 312, the system modifies at least one of the attributes of the media content matching the selected attribute type to produce modified media content. Proceeding to block 314, the system provides the modified media content to the destination device. The method terminates at 316.

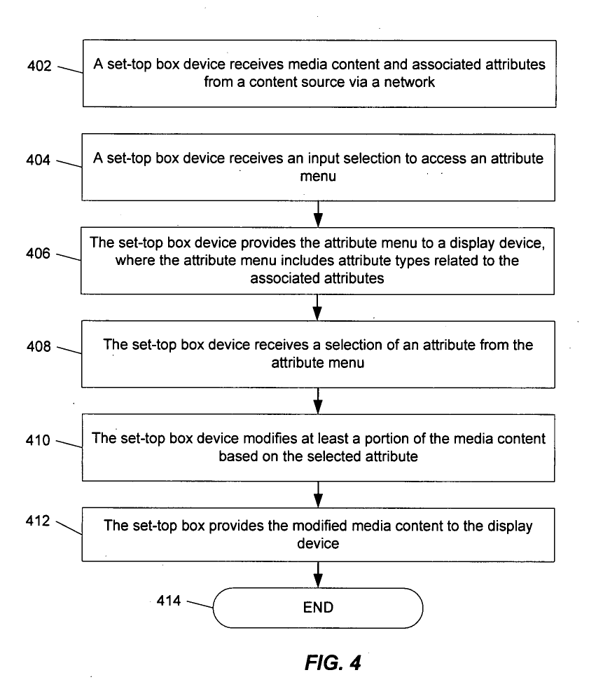

FIG. 4 is a flow diagram of a second particular illustrative embodiment of a method of modifying media content. At block 402, a set-top box device receives media content and associated attributes from a content source via a network. Advancing to block 404, the set-top box device receives an input selection requesting access to an attribute menu. Moving to block 406, the set-top box device provides the attribute menu to a display device, where the attribute menu includes attribute types related to the associated attributes. Proceeding to block 408, the set-top box device receives a selection of an attribute from the attribute menu. Moving to block 410, the set-top box device modifies at least a portion of the media content based on the selected attribute. Continuing to block 412, the set-top box device provides the modified media content to the display device. The method terminates at 414.

In an illustrative embodiment, the set-top box may receive a selection of an attribute related to a particular character's hair color within the media content. The set-top box may change the character's hair color within the media content by modifying the character's corresponding hair color attribute, changing the visual appearance of the actor within the media content. The set-top box device may provide the modified media content to the display device.

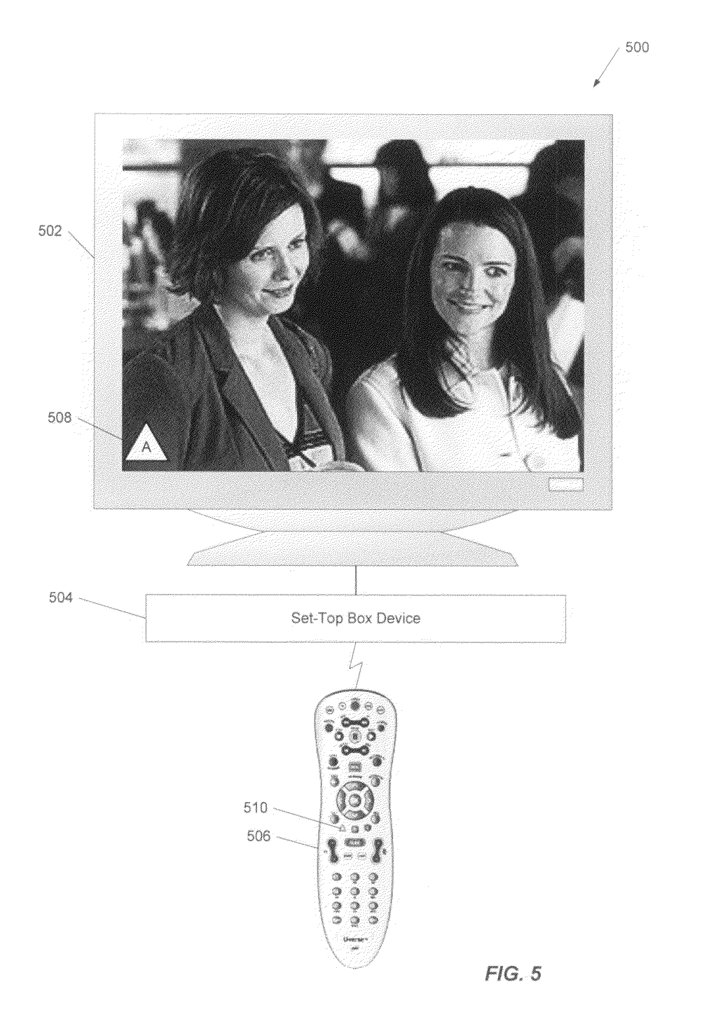

FIG. 5 is a diagram 500 of a particular illustrative embodiment of a user interface including a selectable indicator to access an attribute menu associated with particular media content. The block diagram 500 includes a display device 502, a set-top box device 504, and a remote control device 506. The set-top box device 504 may be coupled to a network, such as the network 108 in FIG. 1, to receive media content with associated attributes from a media content modification system. The set-top box device 504 may be adapted to provide media content to the display device 502 and to receive inputs related to the media content from the remote control device 506.

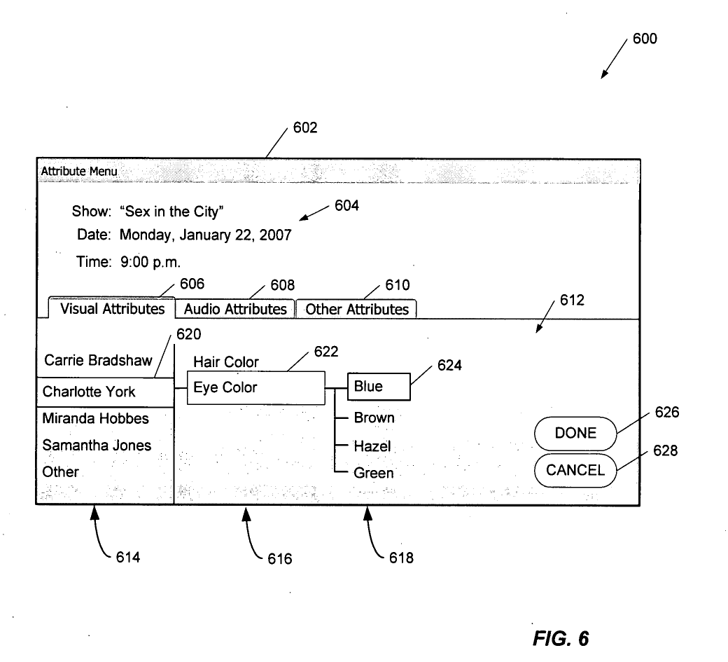

In a particular illustrative embodiment, the set-top box device 504 may provide media content to the display device 502. In a particular illustrative embodiment, the media content may include a visual indicator 508, indicating that the media content includes one or more configurable attributes. An attribute menu of the set-top box device 504 may be accessed to configure the one or more configurable attributes via a button or input key 510 of the remote control device 506. When the visual indicator 508 is present and a user selects the input key 510, an attribute menu may be displayed that is associated with the media content, such as the attribute menu shown in FIG. 6.

FIG. 6 is a block diagram 600 of a second particular illustrative embodiment of a user interface to configure visual attributes associated with particular media content. The block diagram 600 includes an attribute menu 602. The attribute menu 602 may include content information 604 related to particular media content, such as a title, a scheduled date, a scheduled time, other data, or any combination thereof. The attribute menu 602 may also include a plurality of tabs such as a visual attributes tab 606, an audio attributes tab 608, and an other attributes tab 610. A portion 612 of the attribute menu 602 may provide detail associated with a tab. In a particular illustrative example, the visual attributes tab 606 has been selected. The portion 612 of the attribute menu 602 includes a character column 614 including a plurality of selectable characters, an attributes column 616, and a preference column 618. In a particular illustrative embodiment, the user has selected a character 620 (Charlotte York) from the character column 614. Selection of a particular character may result in the display of configurable attributes within the attributes column 616 that are associated with that character. In this instance, a user may configure a hair color attribute or an eye color attribute for the character 620. The user has selected the eye color attribute 622, and a set of color options are provided in the preference column 618, including blue, brown, hazel, and green. The user has selected the preference 624 (blue). When the selections have been made, the user may select a “DONE” button 626 to store the selections. Alternatively, the user may select a “CANCEL” button 628 to cancel the selections. Once the visual attribute selections have been made, the set-top box device, such as the set-top box device 504 in FIG. 5, may modify media content based on the visual attribute selections to display, for example, “Sex in the City” with the character Charlotte York's eye color changed to blue based on the user selections.

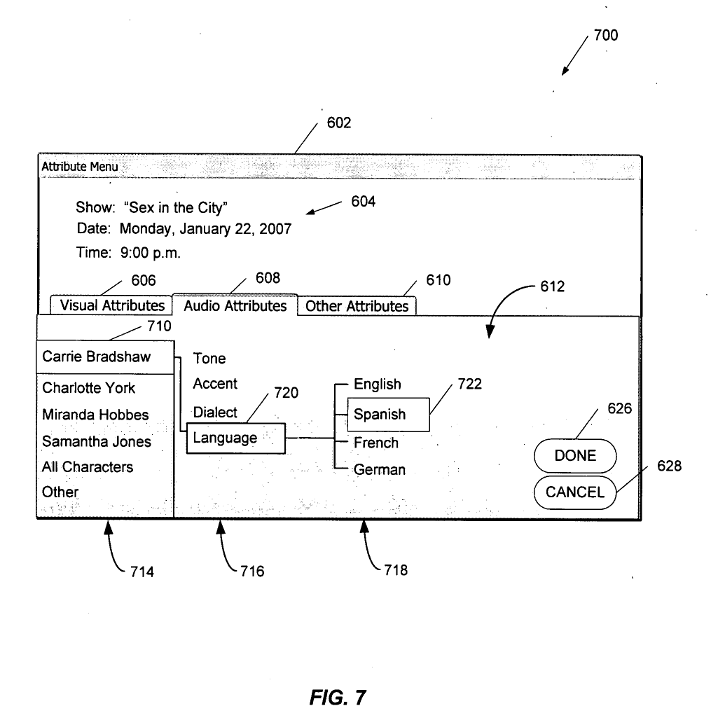

FIG. 7 is a block diagram 700 of a third particular illustrative embodiment of a user interface to configure audio attributes associated with particular media content. The block diagram 700 includes the attribute menu 602. The attribute menu 602 includes the information content 604, the visual attributes tab 606, the audio attributes tab 608, the other attributes tab 610, the portion 612, the “DONE” button 626, and the “CANCEL” button 628. In this example, the audio attributes tab 608 has been selected. The audio attributes tab 618 includes a characters column 714. The audio attributes tab 608 also includes an attributes column 716. The audio attributes tab 608 also includes an preferences column 718. In a particular illustrative embodiment, selection of a character within the characters column 714 may determine which audio attributes may be displayed in the attributes column 716. In this example, the character “Carrie Bradshaw” 710 is selected within the characters column 714. Based on this selection, the configurable attributes in the attributes column 716 include a tone attribute, an accent attribute, a dialect attribute, and a language attribute. The language attribute 720 is selected, and the preferences column 718 displays language options, including English, Spanish, French, and German. In this instance, the Spanish preference 722 is selected. If the user selects the “DONE” button 626, the attribute preferences may be stored, and the set-top box device may display the program “Sex in the City” with a modified audio attribute such that Carrie Bradshaw's spoken lines are reproduced in Spanish. In a particular embodiment, a user may select an accent attribute, and the selected character's spoken lines may be delivered in the selected accent, such as a southern accent, a northeastern accent, a midwestern accent, a Canadian accent, or other accents.

The other attributes tab 610 may allow a user to configure other attributes within a program, including product placement attributes, background and foreground attributes, and other attributes. In general, some programs may include no configurable attributes, while other programs may allow a user to change almost any aspect of the audio content, the video content, or any combination thereof. Some programs may allow a user to configure attributes for each character separately, while other programs may only allow changes to global attributes.

In a particular illustrative embodiment, the user may select an attribute preference from visual attributes that may include eye color, hair color, clothing choice, race, other features, or any combination thereof. In a particular illustrative embodiment, attribute preferences may include facial features such as eye shape, nose shape, cheek bone shape, mouth shape, chin shape, other facial features, or a combination thereof. In another particular illustrative embodiment, a choice of visual attributes preferences may include visual background, degree of sunlight, superimposed hue (e.g., sepia tone), or a combination thereof. In a particular illustrative embodiment, the attribute preference may be selected from audio attributes that may include accent, tone of voice, language, dialect, musical background, other audio attributes, or any combination thereof.

In conjunction with the configuration of structure described herein, the system and method disclosed provide modified media content. In a particular illustrative embodiment, a set-top box device can receive a selection of an attribute from an attribute menu, identifying an attribute associated with media content. In a particular embodiment, the selection may be related to a visual attribute, an audio attribute, or any combination thereof. The set-top box device may change at least a portion of the media content by modifying the corresponding attribute based on the selection. In another embodiment, a content source may receive data related to a selection of an attribute from a destination device, where the data includes a media content selection and an attribute preference. The content source may access the selected media content, identify an attribute associated with the selected media content, and modify the attribute within the media content based on the attribute preference. The content source may provide the modified media content to the destination device.

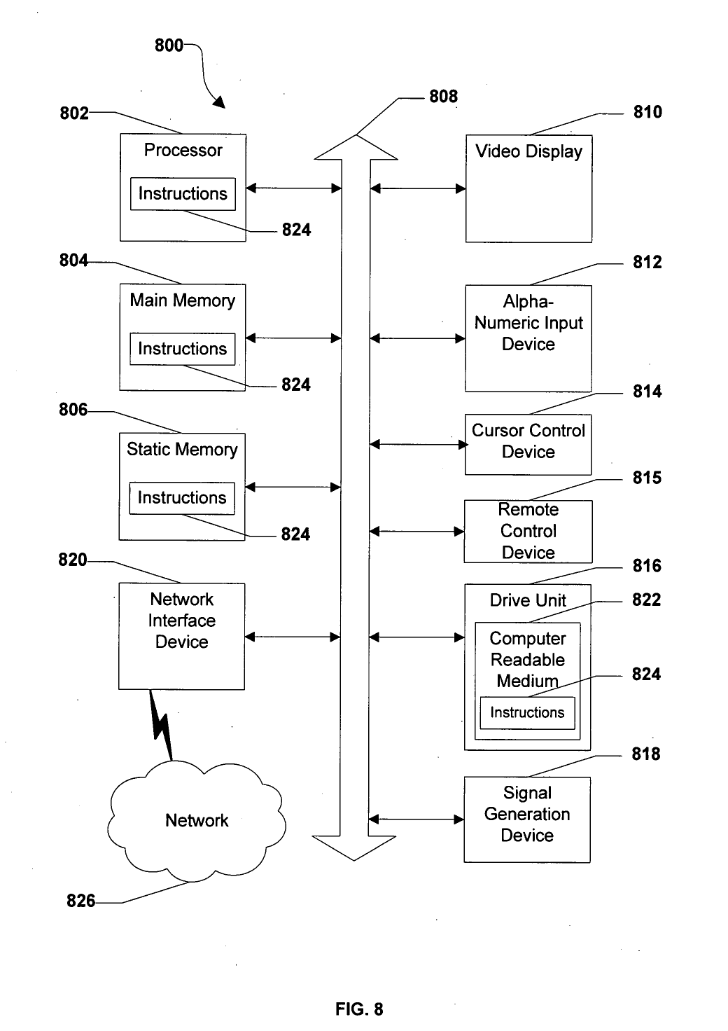

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800, or any portion thereof, may operate as a standalone device or may be connected, e.g., using a public network, such as the Internet, or a private network, to other computer systems or peripheral devices, including one or more set-top box devices, the content sources, the advertising source, or the media content modification system, as depicted in FIGS. 1 and 2.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. Further, the computer system 800 can include a wireless input device 815, e.g., a remote control device. When the computer system 800, or any portion thereof, is embodied in a set-top box device, the cursor control device 814 can be a remote control device. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal; so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of modifying media content, the method comprising:
receiving data from a destination device indicating a media content selection and an attribute preference;
identifying an attribute associated with media content related to the media content selection;
modifying the attribute based on the attribute preference to produce modified media content; and
providing the modified media content to the destination device.

2. The method of claim 1, further comprising identifying a plurality of attributes associated with the media content.

3. The method of claim 1, wherein the media content comprises video data, audio data, or any combination thereof.

4. The method of claim 1, further comprising retrieving the media content from a content source.

5. The method of claim 1, wherein the attribute is identified by parsing the media content to identify one or more discrete characteristics of the media content.

6. The method of claim 1, wherein the attribute comprises a hair color.

7. The method of claim 1, wherein the attribute comprises an eye color.

8. The method of claim 1, wherein the attribute comprises an audio attribute.

9. The method of claim 8, wherein the audio attribute comprises a tone attribute.

10. The method of claim 8, wherein the audio attribute comprises an accent attribute.

11. The method of claim 8, wherein the audio attribute comprises a dialect attribute.

12. The method of claim 8, wherein the audio attribute comprises a musical accompaniment.

13. The method of claim 1, wherein the attribute comprises a height, a weight, a body type, or any combination thereof.

14. The method of claim 1, wherein the attribute comprises a product placement.

15. A method of modifying media content, the method comprising:
sending an attribute interface to a display device, the attribute interface including a plurality of selectable options related to modifiable attributes of media content;
receiving a selection of one of the plurality of selectable options via the attribute interface;
modifying media content based on the selection to produce modified media content; and
providing the modified media content to the display device.

16. The method of claim 15, further comprising:
receiving the media content from a content source;
identifying the modifiable attributes within the media content; and
generating the attribute interface.

17. The method of claim 15, further comprising:
receiving the media content from a content source, the media content including the modifiable attributes and a user selectable indicator of the modifiable attributes;
receiving an input related to the selectable indicator; and
providing the attribute interface to the display device.

18. The method of claim 15, wherein the selection relates to a hair color attribute and wherein modifying the media content comprises replacing a hair color associated with at least one, character associated with the media content.

19. The method of claim 15, wherein the selection relates to an eye color attribute and wherein modifying the media content comprises replacing an eye color associated with at least one character associated with the media content.

20. The method of claim 15, wherein the selection relates to an audio accent and wherein modifying the media content comprises replacing an audio accent associated with at least one character associated with the media content.

21. A system to modify media content, the system comprising:
a memory to store media content including audio data and video data, and to store attribute preferences related to the media content;
a visual attribute detection module to determine a set of visual attributes related to the media content;
an audio attribute detection module to determine a set of audio attributes related to the media content; and
a content modification module to retrieve the media content from the memory and to modify at least one attribute of the set of visual attributes, of the set of audio attributes, or any combination thereof, based on the attribute preferences, to produce modified media content.

22. The system of claim 21, further comprising a processor having access to the memory, wherein the visual attribute detection module, the audio attribute detection module, and the content modification module comprise processor readable instructions executable by the processor.

23. The system of claim 22, further comprising a display device interface, wherein the processor provides the modified media content to a display device via the display device interface.

24. The system of claim 21, further comprising two or more processors, wherein the visual attribute detection module, the audio attribute detection module, and the content modification module comprise processor readable instructions executable by the two or more processors.

25. The system of claim 21, wherein the set of visual attributes comprises a hair color attribute, an eye color attribute, a skin color attribute, and an object color attribute.

26. The system of claim 21, wherein the set of audio attributes comprises a language attribute, a dialect attribute, an accent attribute, and a tonal attribute.

27. A processor readable medium embodying processor readable instructions executable by a processor, the processor readable instructions comprising:
instructions to receive an input selection including a media content selection and an attribute preference;
instructions to determine one or more attributes associated with media content related to the media content selection, the media content comprising video data, audio data, or any combination thereof, and
instructions to modify at least one of the one or more attributes based on the attribute preference to produce modified media content.

28. The processor readable medium of claim 27, wherein the one or more attributes comprise a visual attribute selected from a group consisting of a background, a product placement, and a skin color.

29. The processor readable medium of claim 27, wherein the one or more attributes comprise an audio attribute selected from a group consisting of a dialogue enhancement, a bass enhancement, a musical accompaniment, a dialect attributed and an accent attribute.
